(19) United States
(12) Patent Application Publication
(10) Pub. No.: US 2026/0356223 A1
(43) Pub. Date: Nov. 12, 2026

(54) SYSTEM FOR ELECTRIC AND HYBRID VEHICLES

(71) Applicant: Kiekert Aktiengesellschaft, Heiligenhaus (DE)

(72) Inventor: Marco EGGERT, Leichlingen (DE)

(73) Assignee: Kiekert Aktiengesellschaft, Heiligenhaus (DE)

(21) Appl. No.: 19/113,457

(22) PCT Filed: Sep. 26, 2023
(86) PCT No.: PCT/EP2023/076539

§ 371 Date: Mar. 20, 2025

(30) Foreign Application Priority Data
Sep. 27, 2022 (DE) 10 2022 124 748.1

(51) Int. Cl. B60L 53/302; B60L 53/16

(52) U.S. Cl. CPC B60L 53/302; B60L 53/16

(57) ABSTRACT

The invention relates to a system with a charging plug connector (1) for electric and hybrid vehicles (18) and a control unit (8), the charging plug connector (1) having a housing (7), charging contacts (2) arranged in the housing (7) for contacting corresponding charging contacts (3) of a corresponding charging plug connector (4), and a cooling element (5), which is coupled to at least one of the charging contacts (2) in such a way that the charging contact (2) can be cooled by the cooling element (5), the cooling element (5) is connected to the control unit (8) so that the cooling function of the cooling element (5) is controllable by means of the control unit (8), and the control unit (8) is designed to activate the cooling function of the cooling element at a time outside a charging operation. In this way, charging of a battery of the electric or hybrid vehicle (18) with high current over a longer period of time is made possible.

The invention relates to a system with a charging plug connector for electric and hybrid vehicles, wherein the charging plug connector has a housing, charging contacts arranged in the housing for contacting corresponding charging contacts of a corresponding charging plug connector, and a cooling element, which is coupled to at least one of the charging contacts in such a way that the charging contact can be cooled by the cooling element.

Electric and hybrid vehicles have a rechargeable energy storage device, usually a high-voltage battery, which provides energy to an electric drive motor during driving operation. The storage capacities of these high-voltage batteries are limited so that they must be regularly recharged at a charging station. The battery is charged via a charging cable provided between the charging station and the vehicle, wherein the charging cable is provided on one side with a charging plug that can be plugged into a charging socket provided on the charging station, and on the other side with a charging coupling that can be connected to a built-in charging plug installed in the electric and hybrid vehicle, for example in accordance with the European standard IEC 62196 Type 2. In the present case, charging sockets, charging plugs, charging couplings and built-in charging plugs are subsumed under the term “charging plug connector.” Charging sockets and charging couplings have contact sleeves as charging contacts, and charging plugs as well as built-in charging plugs that can be installed in electric and hybrid vehicles have contact pins as charging contacts that can be plugged into the contact sleeves.

As explained, for example, in EP 3 043 421 A1, a charging current flowing through the charging plug connector causes it to heat up due to ohmic current heat losses. However, the heating of the charging plug connector is limited to a threshold temperature increase. For example, according to the IEC 62196-3 standard, the limit temperature increase is limited to 50 K. This in turn leads to a maximum charging current, which generally cannot exceed 200 A in continuous load operation, for largely standardized connector geometries. However, when the battery of an electric or hybrid vehicle is charged intermittently, higher charging currents are necessary over limited periods of time in order to charge the battery in the desired short time. This may lead to temporary heating of the charging plug connectors above the limit temperature increase. The cable cross-section of the electrical connection bodies cannot be increased arbitrarily, since the plug connector geometries are standardized and, in addition, the smallest possible amount of conductive material, usually copper, should be used for the electrical connection bodies.

In this respect, according to EP 3 043 421 A1, the object to be achieved is to provide an electrical connection body which enables increased charging currents with limited heating and therefore has an increased short-time current carrying capacity. This object is to be achieved by providing an electrical connection body for a charging plug or a charging socket, wherein the electrical connection body has a first connection region for galvanic connection to an electrical energy receiver and a second connection region for galvanic connection to an electrical energy source, wherein the electrical connection body is designed such that it has a cooling fluid channel formed in the electrical connection body, wherein the cooling fluid channel of the electrical connection body is fluidically connected to a cooling fluid source which is arranged in a charging station.

Cooling of a charging plug connector for electric and hybrid vehicles, which originates from the side of the charging station, is also well known from the prior art. DE 10 2015 119 338 A1 describes that two connection points for coolant lines are arranged on a contact sleeve element of a charging plug. By means of a spiral-shaped plug-on element, coolant is guided circularly around the contact sleeve element. The two connection points serve as inlet and outlet for the coolant, which is fed from the charging station to the charging plug. EP 3 433 902 B1 also describes a plug connector part with cooled contact elements. Here, too, the charging station provides for the supply of a coolant via coolant lines to the contact elements of the charging coupling connected to the charging cable. A fluid is provided as a coolant, which is directed perpendicular to the contact element into the hollowed-out contact element and flows back within the contact element. Finally, 10 2016 105 361 B4 also describes a plug connector part with a cooled contact element, wherein here too, on the charging station side, the supply of a coolant via coolant lines to the contact elements of a charging socket connected to the charging cable is provided. Guide elements are arranged on the contact elements to ensure that the coolant in the form of compressed air flows around the contact elements.

Based on this, the object of the present invention is to enable charging of a battery of an electric or hybrid vehicle with high currents over a longer period of time.

The object of the invention is achieved by the subject matter of the independent claims. Preferred developments of the invention are described in the dependent claims.

According to the invention, a system is thus provided with a charging plug connector for electric and hybrid vehicles and a control unit, wherein the charging plug connector has a housing, charging contacts arranged in the housing for contacting corresponding charging contacts of a corresponding charging plug connector and a cooling element, which is coupled to at least one of the charging contacts in such a way that the charging contact can be cooled by means of the cooling element, the cooling element is connected to the control unit so that the cooling function of the cooling element is controllable by the control unit, and the control unit is design to activate the cooling function of the cooling element at a time outside a charging operation.

When reference is made to a corresponding charging plug connector in the present case, this means, on the one hand, a charging plug connector which has the same connector face as the charging plug connector according to the invention, wherein the one connector face, however, has contact pins if the other connector face has contact sleeves, and vice versa. The set consisting of the charging plug connector according to the invention and the corresponding charging plug connector can therefore be plugged together. On the other hand, in the present case, a charging connector is also referred to as a corresponding charging connector if the connector faces in the aforementioned sense only partially correspond, i.e., the corresponding charging connector, for example, does not have all the contacts that are present in the charging connector according to the invention, but the existing contacts of the corresponding charging connector correspond to the charging connector according to the invention in terms of the connector face so that the charging connector according to the invention and the corresponding charging connector can also be plugged together in this case.

Such a case occurs, for example, with a charging coupling connected to a charging cable for direct current charging in accordance with the European standard IEC 62196 Type 2. Such a charging coupling can be plugged into a built-in charging plug installed in the body of an electric or hybrid vehicle and suitable for alternating current charging as well as direct current charging, wherein the AC connector face of the DC charging coupling only has the communication contacts and the protective contact, but no contacts for outer conductors and a center conductor for alternating current charging.

In the present case, a cooling element is understood to be an element which results in active cooling of the charging contacts by the cooling element in the system according to the invention, which comprises a charging plug connector and a control unit. By means of active cooling, the charging contacts of the charging plug connector according to the invention are cooled at a time outside the charging operation, so that the charging contacts have a temperature that is lower than the ambient temperature when the charging operation begins. This means that the maximum permissible limit temperature is reached later when charging with higher charging currents. Compared to a charging operation with charging contacts that are at ambient temperature, the system according to the invention enables a longer charging operation with higher charging currents.

There are different ways to detect whether a charging operation is taking place or not. The control unit can, for example, be connected to communication contacts of the charging plug connector so that a charging operation can be registered via the communication contacts. Likewise, the control unit can be connected to the charging contacts to detect a charging operation. The control unit is designed to cool the charging contacts only at a time outside a charging operation. It is possible that the control unit is arranged in the charging plug connector in order to offer a more compact design of the system according to the invention. In particular, however, the control unit can also be arranged outside the charging plug connector.

It is therefore a key aspect of the invention to enable a longer charging operation with higher charging currents by means of pre-cooling the charging contacts, so that a larger amount of electrical energy can be transferred, particularly in the case of intermittent charging. The invention also serves to bridge the period at the beginning of a charging operation in which cooling from the charging station has to start up first and is therefore not yet effectively available for the charging contacts of the charging plug connector according to the invention. The cooling element is thermally coupled to the charging contacts so that the charging contacts can be cooled efficiently. It is very particularly preferred that the cooling element contacts the charging contact directly, i.e., without electrical insulation. The cooling element can also be equipped with heat pipes that enable a thermal connection with the charging contacts. Solid material pipes with high thermal conductivity are preferably used as heat pipes. The cooling element can also be coupled to the charging contacts using a thermally conductive paste.

According to a preferred development of the invention, it is provided that the time outside a charging operation is a time immediately before a currently planned charging operation. The cooling capacity of the cooling element is known, so that the minimum achievable temperature of the charging contacts in relation to the ambient temperature is also known. The minimum achievable temperature is the lowest possible temperature that can be achieved taking into account the ambient temperature and the cooling capacity. For more efficient cooling, it can therefore be planned that the cooling starts at a certain time before a planned charging operation, so that the charging contacts have the minimum achievable temperature when the charging operation starts.

In principle, the cooling element can be formed in different ways. However, according to a preferred development of the invention, the cooling element is a Peltier element. A Peltier element is an electrothermal converter that generates a temperature difference based on the Peltier effect when current flows through it. Peltier elements can be used for both cooling and heating. In this case they are used for cooling. Peltier elements are therefore cooling elements that do not require any fluidic connections to the charging contacts.

The temperature of the charging contacts and the corresponding charging contacts is equalized via the charging contacts that are connected in the coupled state, so that, due to the pre-cooling at the beginning of the charging operation, they have an overall temperature that is lower than the ambient temperature. This is particularly useful if the corresponding charging plug connector is equipped with an active cooling system, as described above with reference to the prior art. By means of the system provided according to the invention, the temperature of the charging contacts of the charging plug connector and the temperature of the corresponding charging contacts of the corresponding charging plug connector can be kept below the limit temperature increase until the active cooling system provided by the charging station is activated.

According to a preferred development of the invention, it is provided that the Peltier element having a hot side and a cold side is thermally conductively connected to the charging contact with the cold side, and the hot side is coupled to the environment in such a way that heat transfer from the charging contact to the environment is possible. This prevents the heat dissipation from the hot side from heating up the charging plug connector and thus inhibiting the cooling of the charging contacts. For this purpose, the Peltier element can protrude from the housing of the charging plug connector and cooling is achieved via convection. However, fluid-based cooling can also be implemented on the hot side of the Peltier element. It is also conceivable that the hot side is thermally connected to the body of a vehicle via heat pipes, so that the heat generated on the hot side can be dissipated via the body.

In this context, it is also preferable that the hot side is connected to an additional convection element in such a way that heat transfer to the environment via the convection element is possible by convection. For this purpose, the convection element can be thermally coupled to the hot side of the Peltier element via a heat-conducting paste. The convection element preferably protrudes from the housing of the charging plug connector to enable effective heat dissipation to the environment by means of convection.

It is further preferred that the system comprising the charging plug connector and the control unit is provided with a connection area in the housing in which the charging contacts are galvanically conductively connected to electrical lines leading away from the charging plug connector, wherein the charging contacts have a recess in the connection area in which the cooling element is arranged. The recess makes it possible to ensure a large contact area between the charging contact and the cooling element.

In this case, the connection area of the charging plug connector is the area of the charging plug connector in which the charging contacts are galvanically conductively connected to electrical lines leading away from the charging plug connector.

In principle, the system with the charging plug connector and the control unit can be equipped with only one cooling element. However, according to a preferred development of the invention, it is provided that the system according to the invention has a further cooling element, wherein the further cooling element is connected to the control unit and is connected to a further one of the charging contacts in such a way that the further charging contact can be cooled by the cooling element. Specifically, according to a preferred development of the invention, each charging contact is provided with its own cooling element.

The invention also relates to the use of a system described above in an electric or hybrid vehicle. The charging plug connector can be designed according to the European standard IEC 62196 Type 2.

Furthermore, the invention relates to a method for operating a charging plug connector for electric and hybrid vehicles, wherein the charging plug connector has charging contacts for contacting corresponding charging contacts of a corresponding charging plug connector and a cooling element which is coupled to at least one of the charging contacts such that the charging contact can be cooled by the cooling element, comprising the following method steps:
S1) detecting whether a charging operation is currently taking place,
S2) switching on the cooling element only when it has been detected that no charging operation is taking place.

It is important to note that cooling can only take place at times outside a charging operation. For this purpose, it is detected whether a charging operation is currently taking place or not. However, this does not mean that cooling is always taking place when no charging operation is taking place. Cooling is started at a time between two consecutive charging operations, preferably in such a way that the minimum achievable temperature is reached when the charging operation is started. Preferably, cooling is carried out in such a way that the minimum achievable temperature is reached immediately before the start of the charging operation.

According to a preferred development of the invention, the method comprises the following further method steps:
S3) detecting that a charging operation is currently taking place or is imminent, and
S4) switching off the cooling element when it has been detected that a charging operation is currently taking place or is imminent.

More preferably, the method additionally comprises the following steps:
S1a) detecting a value for a charging-specific parameter,
S2a) determining a time period, after which a charging operation is to be expected, using the charging-specific parameter,
S2b) switching on the cooling element as soon as the determined time period falls below a predetermined time period threshold.

Here, a charging-specific parameter is detected, which can be used to determine the time period after which a charging operation is to be expected. Switching on the cooling element as soon as the predetermined time period threshold of the predetermined time period is exceeded allows the charging contacts to have the minimum achievable temperature shortly before the charging operation begins. The term “time period” refers to the time interval after which a charging operation is expected. According to a preferred development of the invention, in step S1a a respective value for the charging-specific parameter is successively detected. This makes it possible to continuously check whether the time period falls below the predetermined time period threshold so that the cooling element can be activated at the right moment.

In principle, various parameters can be provided as charging-specific parameters. However, according to a preferred development of the invention, it is provided that the charging-specific parameter is a battery charging value, i.e., a value that indicates the remaining charge of the battery. Such a battery charge value correlates directly with a remaining distance that can be covered, which in turn correlates with the time period threshold. The battery charge level can be used to determine when a charging operation must begin. In the sense of this invention, the distance can correspond to both a spatial and a temporal distance.

According to another preferred development of the invention, the load-specific parameter is a vehicle position. Based on the vehicle position, for example, the distance to a charging station that is to be approached can be determined, so that when the time period threshold is exceeded, the cooling of the charging contacts begins.

According to a further preferred development of the invention, it is provided that the charging-specific parameter is a time of day. Regular journeys allow the cooling of the charging contacts to be switched on depending on the time of day. If charging is expected to begin at certain times of the day, the charging contacts can be cooled accordingly in advance.

Finally, according to a preferred development of the invention, it is also provided that the charging-specific parameter is a value from a vehicle navigation system of an electric or hybrid vehicle, which indicates that the electric or hybrid vehicle is approaching a charging station. In particular, in this context, it is provided that the value from the vehicle navigation of an electric or hybrid vehicle indicates the expected time of arrival at the charging station and/or the time until the electric or hybrid vehicle reaches the charging station.

The invention is described in more detail in the following with reference to the drawings on the basis of preferred exemplary embodiments.

### IN THE DRAWINGS

FIG. 1 schematically shows a system with a charging plug connector and a control unit according to a preferred exemplary embodiment of the invention,

FIG. 2 shows a plug connector corresponding to the plug connector from FIG. 1,

FIG. 3a shows the charging plug connector from FIG. 1 in a side view,

FIG. 3b schematically shows the charging contacts with the cooling elements of the charging plug connector from FIG. 3a,

FIG. 4 shows the cooling element shown in FIG. 3b with a convection element in a schematic view,

FIG. 5 schematically shows the installation of a charging plug connector according to a preferred exemplary embodiment of the invention in the body of an electric or hybrid vehicle, and

FIG. 6 is a flow chart for a method according to a preferred exemplary embodiment of the invention.

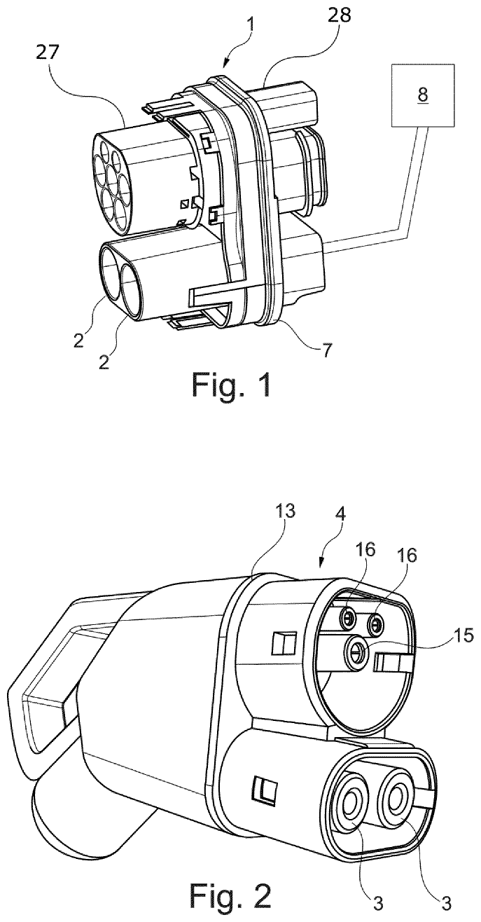

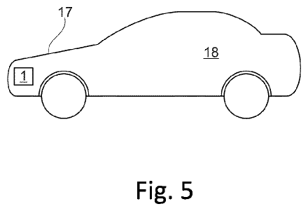

FIG. 1 schematically shows a system with a charging plug connector 1 and a control unit 8 according to a preferred exemplary embodiment of the invention. This is a charging plug for installation in the vehicle body 17 of an electric or hybrid vehicle 18, as shown schematically in FIG. 5. The present charging plug connector 1 is substantially and in terms of its mating face a charging plug in accordance with the European standard IEC 62196 Type 2. In addition to AC charging contacts not further provided with reference signs, the charging plug connector 1 has a protective contact 15, communication contacts 16 and two charging contacts 2 for DC charging.

The charging plug connector 1 is composed of a front housing part 27 and a rear housing part 28. Both housing parts together form the housing 7 of the charging plug connector 1. The front housing part 27 is connected to the rear housing part 28 by laser welding. The front housing part 27 is the housing part which, when installed in a vehicle body 17, faces outwards and is intended to receive a corresponding charging plug connector 4.

Such a corresponding charging plug connector 4 can be seen in a perspective view in FIG. 2. This is a charging coupling for direct current charging, which substantially and in terms of its connector face complies with the European standard IEC 62196 Type 2. For direct current charging, two corresponding charging contacts 3 are provided in a housing 13, which interact with the charging contacts 2 of the charging plug connector 1 during charging. Specifically, the charging contacts 2 of the charging plug connector 1 are designed as contact pins and the corresponding charging contacts 3 of the corresponding charging plug connector 4 are designed as contact sleeves into which the contact pins can be inserted. In addition, the corresponding charging plug connector 4 has two communication contacts 16 and a protective contact 15.

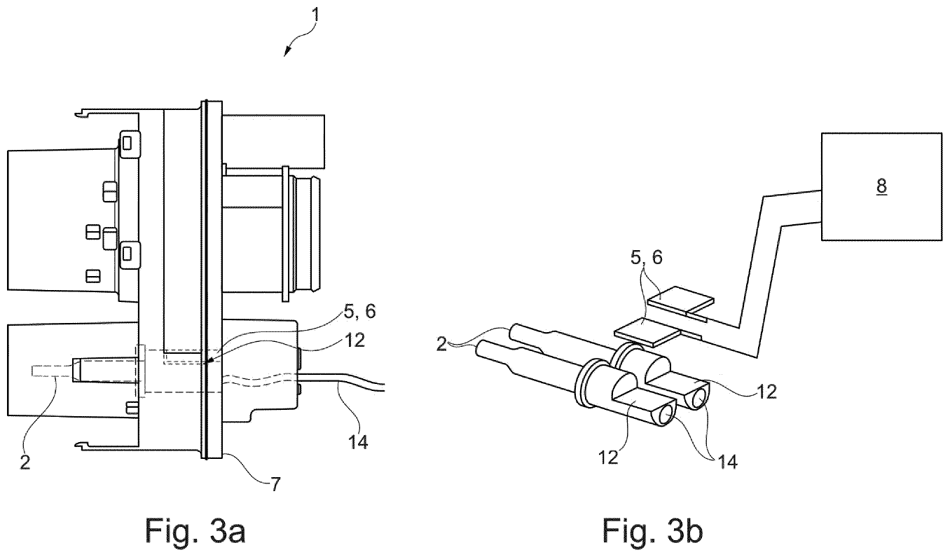

As can be seen in particular from FIG. 3a, the charging plug connector 1 has a plug-in area in the front housing part 27 and a connection area in the rear housing part 28. The plug-in area is defined as an area in which the charging plug connector 1, when plugged into the corresponding charging plug connector 4, overlaps with the corresponding charging plug connector 4 in the plug-in direction and the charging contacts 2, 3 of the two plug connectors 1, 4 are in galvanically conductive contact with each other. The connection area is defined as an area in which the charging contacts 2 of the charging plug connector are galvanically conductively connected to electrical lines 14 that lead from the charging plug connector 1 to a battery (not shown in more detail).

What is important in the preferred exemplary embodiment of the invention described here is that two cooling elements 5, which in this exemplary embodiment are Peltier elements 6, are arranged in recesses 12 of the charging contacts 2. The Peltier elements 6 are arranged with their cold side 10 in the recesses 12 and contact them there. The hot side 9 is located on the side opposite the cold side 10 and is thermally coupled to the vehicle body 17 via heat pipes (not shown). The recesses 12 are arranged in the connection area of the charging plug connector 1.

FIG. 3b shows in perspective the charging contacts 2 of the charging plug connector 1 having the recesses 12. Each charging contact 2 has a recess 12 in which a Peltier element 6 is arranged. The Peltier elements 6 are connected to the control unit 8 and are controlled by it, i.e., in particular activated or deactivated. For this purpose, the control unit 8 is arranged on the vehicle body 17 and is also connected to the communication contacts 16 of the charging plug connector 1.

In this context, however, it should be noted that the arrangement of the Peltier elements 6 in the recesses 12 of the heat conducting element shown in FIG. 3b is very favorable for the heat dissipation from the charging contacts 2. However, other arrangements for the Peltier elements 6 are also conceivable.

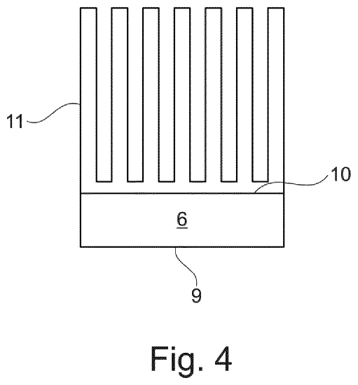

From FIG. 4 it can be seen that, as an alternative to the heat removal of the Peltier element 6 by heat pipes, a convection element 11 can be arranged directly contacting the hot side 10 of the Peltier element 6. The convection element 11 has a particularly high ratio of its surface to its volume, so that a particularly large surface is available for heat dissipation for convection cooling.

It has already been mentioned above that the charging plug connector 1 is used in the form of a built-in plug on the vehicle body 17 of an electric or hybrid vehicle 18. In this context, reference may again be made to FIG. 5, which schematically shows a charging plug connector 1 installed in a vehicle body 17 of an electric or hybrid vehicle 18.

FIG. 6 shows a schematic flow chart showing the sequence of a method for operating a charging plug connector 1 for electric and hybrid vehicles 18 according to a preferred exemplary embodiment of the invention. The first step S1 comprises detecting whether a charging operation is currently taking place. Subsequently, in a step S1a, a respective value for a charging-specific parameter is successively detected. The charging-specific parameter in this case is the state of charge of the battery of the electric or hybrid vehicle 18. In a further step S2a, a time period after which a charging operation is to be expected is determined based on the charging-specific parameter. Specifically, the expected residual range is continuously calculated in the form of a time period based on the battery charge level. As soon as the time period falls below a predetermined time period threshold, the cooling element 5 is switched on by the control unit 8 in step S2b. In a further step S3, it is again detected whether a charging operation is taking place or is imminent. The cooling element 5 is switched off in step S4 if it was detected in step S3 that a charging operation is taking place or is imminent.

### LIST OF REFERENCE SIGNS

1 Charging plug connector
2 Charging contact
3 Corresponding charging contact
4 Corresponding charging plug connector
5 Cooling element
6 Peltier element
7 Housing
8 Control unit
9 Hot side
10 Cold side
11 Convection element
12 Recess
13 Housing
14 Electrical line
15 Protective contact
16 Communication contact
17 Vehicle body
18 Electric or hybrid vehicle
19 Cooling element
27 Front housing part
28 Rear housing part

1. A system comprising:
a charging plug connector for electric and hybrid vehicles and a control unit, wherein the charging plug connector comprises:
a housing,
charging contacts arranged in the housing for contacting corresponding charging contacts of a corresponding charging plug connector, and
a cooling element, which is coupled to at least one of the charging contacts in such a way that the charging contacts are cooled by a colling function of cooling element,
wherein the cooling element is connected to the control unit so that the cooling function of the cooling element is controllable by the control unit, and
wherein the control unit is configured to activate the cooling function of the cooling element at a time outside of a charging operation.

2. The system according to claim 1, wherein the time outside of the charging operation is a time before a currently scheduled charging operation.

3. The system according to claim 1, wherein the cooling element is a Peltier element.

4. The system according to claim 3,
wherein the Peltier element includes a hot side and a cold side,
wherein the Peltier element is conductively connected to the charging contacts with the cold side, and
wherein the hot side is coupled to an environment in such a way that the Peltier element is configured to transfer heat from the charging contacts to the environment.

5. The system according to claim 4,
wherein the Peltier element further includes a convection element, and
wherein the hot side is connected to the convection element in such a way that the Peltier is configured to transfer heat to the environment via the convection element by convection.

6. The system according to claim 1, wherein the cooling element directly contacts the charging contact.

7. The system according to claim 1 further comprising a connection area in the housing in which the charging contacts are galvanically conductively connected to electrical lines leading away from the charging plug connector, wherein the at least one of the charging contacts has a recess in the connection area in which the cooling element is arranged.

8. A method for operating a charging plug connector for electric and hybrid vehicles, wherein the charging plug connector has charging contacts for contacting corresponding charging contacts of a corresponding charging plug connector and a cooling element, wherein the cooling element is coupled to at least one of the charging contacts such that the at least one of the charging contacts is configured to be cooled by the cooling element, the method comprising the steps of:
S1) detecting whether a charging operation is currently taking place,
S2) switching on the cooling element only when it has been detected that no charging operation is taking place.

9. The method according to claim 8 further comprising the steps of:
S3) detecting that a charging operation is currently taking place or is imminent, and
S4) switching off the cooling element when it has been detected that a charging operation is currently taking place or is imminent.

10. The method according to claim 8 further comprising the steps of:
S1a) detecting a value for a charging-specific parameter,
S2a) determining a time period, after which a charging operation is to be expected, using the charging-specific parameter,
S2b) switching on the cooling element as soon as the determined time period falls below a predetermined time period threshold.

11. The method according to claim 10, wherein in step S1a, a respective value for the charging-specific parameter is successively detected.

12. An electric or hybrid vehicle comprising system according to claim 1.

13. The system according to claim 4, wherein the environment is a vehicle body.

14. The system according to claim 5, wherein the hot side thermally coupled to the vehicle body via heat pipes.

15. The method according to claim 10, wherein the charging-specific parameter is a time of day.

16. The method according to claim 10, wherein the charging-specific parameter is a battery charging value.

17. The method according to claim 10, wherein the charging-specific parameter is a load-specific parameter.
